(19) United States
(12) Patent Application Publication
(10) Pub. No.: US 2005/0237996 A1
(43) Pub. Date: Oct. 27, 2005

(54) Electronic apparatus system and data control apparatus

(75) Inventors: Yuichi Sakuraba, Tokyo (JP); Yosuke Ishii, Tokyo (JP); Shuji Yamamoto, Tokyo (JP); Yasutaka Hino, Tokyo (JP); Harumi Wada, Tokyo (JP); Masato Yamaji, Tokyo (JP); Yasuyuki Fujii, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/111,191

(22) Filed: Apr. 20, 2005

(30) Foreign Application Priority Data
Apr. 21, 2004 (JP) 2004-124895

(51) Int. Cl. H04B 1/00; G06F 7/04; G08B 21/00

(52) U.S. Cl. 370/351

(57) ABSTRACT

An electronic apparatus system has an electronic apparatus which transmits data through a communication network, a data control apparatus which is connected to the electronic apparatus through the communication network and stores data transmitted from the electronic apparatus, and a computer which enables to communicate with the data control apparatus, wherein the data control apparatus transmits the stored data to the computer.

### CROSS-REFERENCE TO RELATED APPLICATIONS

This application is based upon and claims the benefit of priority from the prior Japanese Patent Applications No. 2004-124895, filed on Apr. 21, 2004, the entire contents of which are incorporated herein by reference.

### BACKGROUND OF THE INVENTION

1. Field of the Invention

The present invention relates to an electronic apparatus system constituted by electronic apparatuses, such as programmable logic controllers, that operate and monitor apparatuses that are provided for various industrial processes, or that are installed on factory production lines or in various experimental facilities, adjustment apparatuses, data collection apparatuses, for collecting data of various types, recorders and oscilloscopes, and a computer connected to the electronic apparatuses via a communication network that transmit various instructions to and exchange data with the electronic apparatuses. The present invention also relates to a data control apparatus that is connected to the electronic apparatuses through the communication network and enables to communicate with the computer.

2. Description of the Related Art

The following documents are related to an electronic apparatus system constituted by various types of electronic apparatuses and a computer, to which the electronic apparatuses are connected, that transmits various instructions to and exchanges data with the electronic apparatuses.

JP-T-2002-503410 and U.S. Pat. No. 5,805,442 are referred to as related art.

FIG. 4 is a block diagram plainly showing the configuration of a related electronic apparatus system.

In FIG. 4, an electronic apparatus 10, which operates, monitors, controls and performs data collection for apparatuses that are provided for various types of industrious processes, or are installed on a factory production line or in various experimental facilities, has: a control block 11, a web server 12 and a web page 13, used to handle input/output data related to the control block

The control block 11 is the core of the electronic apparatus 10, which operates, monitors, controls and collects data of various types for apparatuses that are provided for various industrious processes, or are installed on production lines or in various experimental facilities.

The web server 12 is a block having an included, commonly employed web server function.

The web page 13 is a block fetching data collected by the control block 11 and having an included software program component, such as a JAVA applet downloaded and executed by a client (JAVA, a trademark registered by Sun Microsystems, Inc., is an object oriented programming language that is hereinafter referred to simply as “JAVA”).

The electronic apparatus 10 is connected via a network interface 14 to a communication network L, such as the Internet or a local area network LAN, using a wired connection method or a wireless connection method.

A plurality of the electronic apparatuses 10 and a plurality of computers 20 may be connected to the communication network L.

The computer network 20 is a common client computer that includes a display device 21 and browser software 23 and is connected, via a network interface 22, to the communication network L.

In this electronic apparatus system, on the client side, the browser software 23 of the computer 20 accesses the electronic apparatus 10, as needed. When an access is detected, the web server 12 of the electronic apparatus 10 transmits various instructions and data from the web page 13 to the browser software 23 via the network interface 14, the communication network L and the network interface 22 of the computer 20. Then, the browser software 23 interprets the thus downloaded instructions and data and displays the results obtained on the display device 21.

More specifically, for example, the control block 11, which has a temperature measurement function, collects temperature data for the local area and transmits the data to the computer 20, along with a designated thermometer graphic obtained from the web page 13. Once the data and instructions have been received, the browser software 23 uses the temperature data and the thermometer graphic to prepare a graphical temperature presentation that it displays on the display device 21.

In this manner, in the related electronic apparatus system, the computer 20 and the electronic apparatus 10 communicate directly to obtain required data or to exchange setup information, and the computer 20 uses the web page form to monitor the electronic apparatus 10.

When the computer 20 has previously determined the presence of the electronic apparatus 10, and employs HTTP (Hyper Text Transfer Protocol) as the communication protocol, the computer 20 uses the URL (Uniform Resource Locator) of the electronic apparatus 10 to access the web server 12. To access data, the computer 20 will also, when required, perform an authentication process.

When a special communication application is installed in the computer 20, the same processing is performed as when HTTP is employed, and a user designates an electronic apparatus 10 to be connected and accesses data.

However, the following problems have arisen with the related electronic apparatus system.

The electronic apparatus 10 must internally store and manage obtained information.

Specifically, a storage function is required for the electronic apparatus 10. So long as only the storage of information for the setup of the electronic apparatus 10 is required, a flash ROM is sufficient. However, when data obtained externally is to be stored, additional hardware is required because the size of the data is generally larger than the size of the setup information. As is described above, a function for managing a large storage section is required for the electronic apparatus 10, and while taking the cost of the hardware into account, the total cost is increased.

Furthermore, generally it is difficult for a very high processing capability to be built into the related electronic apparatus 10, and in many cases, it is also hard to obtain the processing capability needed for a storage management function.

Further, in the case that the electronic apparatus 10 includes a storage device, such as a hard disk, having many movable portions, the reliability of the electronic apparatus 10 would be degraded.

In addition, when a plurality of the electronic apparatuses 10 are connected to the communication network L, providing a storage section for each of the electronic apparatuses 10 is not efficient. And although, for multiple electronic apparatuses 10, a mechanism could be mounted on each that permits a storage section provided for one to be shared by all the others, implementing such a method would make the system overly complicated.

Moreover, changing the operation of the electronic apparatuses 10 by adding such a function could not easily be coped with.

Were a change in the access method or the addition of the function to be requested by the computer 20, a mechanism that could cope with such a change would have to be installed in each of the electronic apparatuses 10.

Especially when electronic apparatuses 10 employ the web pages 13 to generate screens to be displayed by the computer 20, the same correction process would have to be performed for all the electronic apparatuses 10 connected to the computer 20.

Generally, the firmware for an electronic apparatus 10 is supplied as a ROM, and unlike the computer 20, is not easily updated. Therefore, information (especially for a screen) that an electronic apparatus 10 can provide for the computer 20 is more or less a general-purpose item, and is not easily customized for individual users.

Furthermore, the computer 20 must obtain, in advance, the access means for each electronic apparatus 10. For a system constituted by electronic apparatuses 10 of different types, the means for accessing information stored in the electronic apparatuses 10 can not be integrated.

Thus, for each electronic apparatus 10, the computer 20 must introduce, in advance, means for accessing each electronic apparatus 10 (e.g., the URL registration for a web or the install for a special application).

The integration and structuring of data obtained from a plurality of electronic apparatuses 10 must be performed by the computer 20.

Since the computer 20 and the electronic apparatuses 10 communicate directly, the computer 20 must integrate the data forms used by the electronic apparatuses 10 in order to monitor the data received from the electronic apparatuses 10 while the data are monitored in association with each other.

As another problem, the data backup process used by the computer 20 is complicated. That is, since the data are spread out among the individual electronic apparatuses 10, the backup operation performed for the data received from the apparatuses 10 is complicated.

The electronic apparatuses 10 must include a function for providing security. When the access control process is performed, by the computer 20, for the data stored in the electronic apparatuses 10, authentication information for the electronic apparatuses 10 must be provided. Therefore, since the account information can not be managed one-dimensionally, the management costs are increased.

### SUMMARY OF THE INVENTION

An object of the invention is a simplification of the configuration of the entire system, so as to avoid a cost increase, and a reduction in the number of procedures performed in response to a request to update or improve the function.

The invention provides an electronic apparatus system, having: an electronic apparatus which transmits data through a communication network; a data control apparatus which is connected to the electronic apparatus through the communication network and stores data transmitted from the electronic apparatus; and a computer which enables to communicate with the data control apparatus, wherein the data control apparatus transmits the stored data to the computer.

In the electronic apparatus system, the data control apparatus structures the stored data into data having a form desired by the computer to transmit the data having the form to the computer.

In the electronic apparatus system, the desired form is a web page form.

In the electronic apparatus system, the data control apparatus has a storage section including a data storage section which stores the data transmitted from the electronic apparatus, and a web page setup section which sets up a web page.

In the electronic apparatus system, the data control apparatus distributes a web page formed by combining data transmitted from a plurality of the electronic apparatuses.

In the electronic apparatus system, the computer and the data control apparatus are integrally configured.

In the electronic apparatus system, the data control apparatus controls a sequence of provision of the web page or a band of the communication network to be used for the provision of the web page, according to an access request source or access contents.

In the electronic apparatus system, the data control apparatus manages a history of data requests made by the computer.

In the electronic apparatus system, the data control apparatus changes a form of data to be provided, according to an attribute of an access source.

The invention also provides a data control apparatus which is connected to an electronic apparatus through a communication network and enables to communicate with a computer, having: a data storing section which stores data transmitted from the electronic apparatus; and a communication section which transmits data stored in the data storing section to the computer.

According to the electronic apparatus system and the data control apparatus, the following advantages can be obtained.

(1) A large storage section need not be prepared and installed in an electronic apparatus, and additional hardware is not required. Therefore, once an electronic apparatus is installed in a local area, no change is required and a cost increases incurred by the addition of hardware can be avoided.

(2) A storage management capability is not required for an electronic apparatus, and the degrading of reliability due to the provision of storage is avoided.

(3) The storage provided in one electronic apparatus need not be shared by a plurality of other electronic apparatuses.

(4) An operation for installing, in the individual electronic apparatuses, a mechanism for changing an access method used by the computer or for changing a function is not required. According to the invention, the access means can be integrated.

(5) Since the computer is not responsible for integrating the form of the data obtained from a plurality of electronic apparatuses, the processing load imposed on the computer is reduced.

(6) Since a plurality of integrated electronic apparatuses are provided for the data control apparatus, a data backup operation need not be performed for all the electronic apparatuses, only for one (a data control apparatus), which makes this an efficient method.

(7) Since individual security management means need not be set up for each electronic apparatus, configuring an entire system is simple.

As is described above, according to the electronic apparatus system and the data control apparatus, since the data control apparatus is provided in the communication network, designated entries for individual electronic apparatuses, such as various processes for data management and security, can be eliminated, and the organization of an entire system can be simplified.

### BRIEF DESCRIPTION OF THE DRAWINGS

FIG. 1 is a block diagram showing a configuration for an embodiment of the present invention;

FIG. 2 is a block diagram showing the configuration of an electronic apparatus of the embodiment;

FIG. 3 is a block diagram showing the configuration of a data control apparatus of the embodiment; and

FIG. 4 is a block diagram showing the configuration of a related electronic apparatus system.

### DETAILED DESCRIPTION OF THE PREFERRED EMBODIMENTS

An embodiment of the present invention will now be described in detail while referring to the drawings.

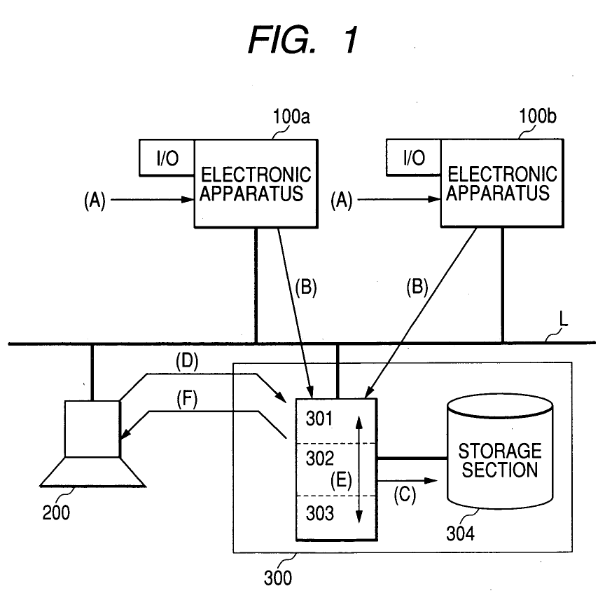

FIG. 1 is a block diagram showing a configuration according to the embodiment of the invention.

In an electronic apparatus system shown in FIG. 1, electronic apparatuses 100a and 100b, a computer 200 and a data control apparatus 300 are connected to a communication network L.

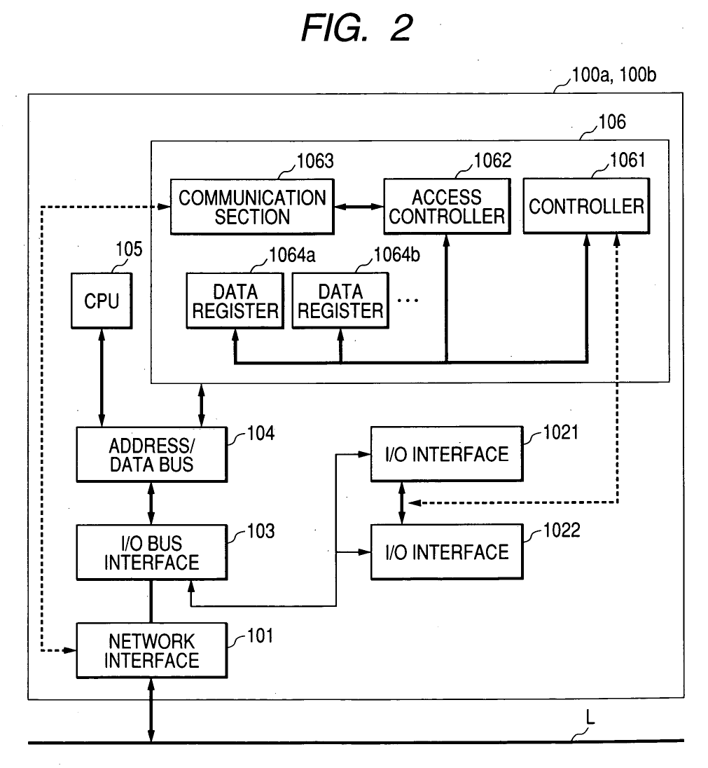

A detailed configuration of the electronic apparatuses 100a and 100b is shown in FIG. 2.

As shown in FIG. 2, each of the electronic apparatuses 100a and 100b has a network interface 101, I/O interfaces 1021 and 1022, an I/O bus interface 103, an address/data bus 104, a CPU 105, and furthermore a remote storage access controller 106.

Through a processing performed by the CPU 105, designated electronic apparatuses 100a and 100b can be set to a device such as programmable logic controllers, recorders or oscilloscopes.

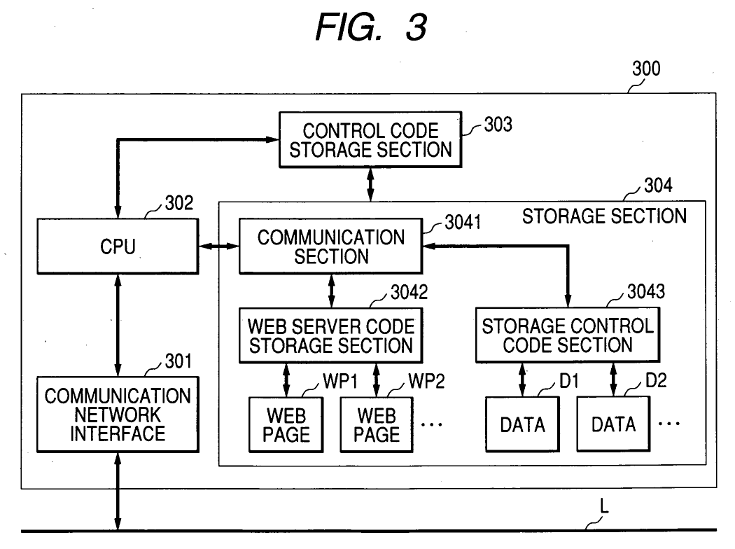

The remote storage access controller 106 block provides facilities for accessing a storage section 304 in the data control apparatus 300 (see FIG. 3), which will be described later, and for transmitting and receiving data and setup information. The remote storage access controller 106 includes: a controller 1061; an access controller 1062, for controlling access to the storage section 304; a communication section 1063, for communicating with the network interface 101; and data registers 1064a, 1064b, . . . , for storing data.

The thus arranged electronic apparatuses 100a and 100b collect information, including processing data, logs and apparatus statuses, related to such designated functions as those for control, and exchange data with the computer 200 and the data control apparatus 300 in FIG. 1. Further, the electronic apparatuses 100a and 100b accept control information, from various connected apparatuses, applied for the electronic apparatuses 100a and 100b.

Furthermore, the electronic apparatuses 100a and 100b employ a general-purpose protocol, or a unique network protocol, for the exchange with the data control apparatus 300, via the communication network L, of data they collect and setup information.

As is described above, the electronic apparatuses 100a and 100b can, for example, be programmable logic controllers or data recorders, and can collect data from various lower level apparatuses, such as thermometers, pressure gauges, flowmeters or contact devices, and can also, depending on the circumstances, internally perform control operations and transmit control operation data to the lower level apparatuses.

The detailed structure of the data control apparatus 300 is shown in FIG. 3.

The data control apparatus 300 has a network interface 301 to be connected to the communication network L, a CPU 302, a control code storage section 303 for storing a control code for accessing the storage section 304, which will be described later, and the storage section 304 for storing various data.

The storage section 304 is a various data storage block. The storage section 304 includes a communication section 3041, a web server code storage section 3042 for storing a web server code for controlling internal web pages WP1, WP2, . . . , and a storage control code storage section 3043 for storing a storage control code for controlling data D1, D2, . . .

In the embodiment, the storage section 304 includes the web server code storage section 3042 for storing the web pages WP1 and WP2, and the storage control code storage section 3043 for controlling the data D1 and D2. However, instead of the web page form, a form desired by the computer 200 may be employed.

That is, the form of data to be distributed or provided can be processed by the data control apparatus 300, and changes performed by the electronic apparatuses 100a and 100b are not required.

According to the configuration, the data control apparatus 300 provides a data storage function, a function for receiving data from the electronic apparatuses 100a and 100b connected to the communication network L, a function for storing received data in the storage section 304, and a function for permitting another system to access the data stored in the storage section 304 and for distributing the data D1, D2, . . . , along with the web pages WP1, WP2, to a different, connected system.

More specifically, the data control apparatus 300 employs the mode of a server computer that accepts an access by the electronic apparatuses 100a and 100b connected to the communication network L, the computer 200 that serves as a remote apparatus, and another data control apparatus 300.

The access request source may not only be the computer 200, but may also be another system connected to the data control apparatus 300.

The data handled by the data control apparatus 300 may include additional information, such as information concerning a data format function or an access module provision function.

The data format function is either a function for changing the format for data, received from the electronic apparatuses 100a and 100b, to one that is easy to process and to use that format when storing the data, a function for changing the format for data, before the data are distributed to the computer 200, to one consonant with the characteristics of the electronic apparatuses 100a and 100b, or a function for additionally providing, for an access request source, information for the formatting of data.

The access module provision function is a function for the distribution, by an access request source, of data display programs or data processing programs, such as various types of applet, components, data conversion code or setup tools.

In other words, the data control apparatus 300 has a web page distribution function, i.e., a function for embedding, in the web pages WP1, WP2, . . . , the data D1, D2, . . . received from the electronic apparatuses 100a and 100b, and for transmitting the web pages W1, W2, . . . to an apparatus, such as the computer 200, that has issued a data access request.

The data control apparatus 300 may include a function for combining data collected from the electronic apparatuses 100a and 100b and for integrating the data and constructing a web page.

Referring again to FIG. 1, the computer 200 in this invention is a common computer, such as a small personal computer, that uses functions provided by the data control apparatus 300 to employ data stored in the electronic apparatuses 100a and 100b or to control the electronic apparatuses 100a and 100b.

The computer 200 is not necessarily one actively operated by an operator, and may be either a computer having a gateway function connected to another system or a higher level controller.

The computer 200 and the data control apparatus 300 need not always be separate apparatuses, they may be integrally formed. That is, the functions of the data control apparatus 300 may be provided for the computer 200, or the functions of the computer 200 may be internally provided for the data control apparatus 300.

For a small scale system, when the introduction of special hardware to serve as the data control apparatus 300 is not a realistic option, the integrated configuration described above may be appropriate for the system at its actual location.

The communication network L can be established by a connection that uses the Internet or a public line, by a direct connection that uses a serial cable or by a wired or wireless connection, and the system can be constructed by using a connection form consonant with the characteristics of the individual apparatuses.

While referring again to FIG. 1, the operation of the thus arranged electronic apparatus system of the invention will now be explained.

(A) Assume that the electronic apparatuses 100a and 100b are programmable logic controllers. When an electronic apparatus 100a or 100b is started, its internal data collection functions collect data produced at an actual site by lower level apparatuses (not shown), such as a thermometer and a contact apparatus, which are connected, and store the obtained data.

(B) The electronic apparatus 100a or 100b then transmits the stored data to the data control apparatus 300, via the communication network L, at a constant interval or at a required time.

(C) Thereafter, the data control apparatus 300 stores the received data in the storage section 304. At this time, the data may be stored in the form in which received, from the electronic apparatus 100a or 100b, or in a converted form, acquired following the completion of a data conversion or compression process.

(D) In this state, the operator of the computer 200 issues an access request to the computer addition apparatus 300, via the communication network L, to read the data on hand that were obtained from the electronic apparatus 100a or 100b.

Subsequently, the operator employs the computer 200 to transmit to the data control apparatus 300 the URL information for the electronic apparatus 100a or 100b.

(E) The data control apparatus 300 interprets the request received from the computer 200 and converts the form of the data to be transmitted into an appropriate data distribution form. However, when in (C) data conversion is not required, the data are provided unchanged.

(F) The data control apparatus 300 provides the internally stored data for the computer 200 that issued the data request. At this time, the data may be distributed in a form consonant with the characteristic of the computer 200.

More specifically, in accordance with a request received from the computer 200, the data control apparatus 300 selects a corresponding electronic apparatus 100a or 100b and provides data, in a form wherein the data D1, D2, . . . are embedded in one of the web pages W1, W2, for the computer 200 and an instruction required for a data display.

At this time, the data control apparatus 300 may transmit the data and the display instruction simultaneously, or separately, through different ports.

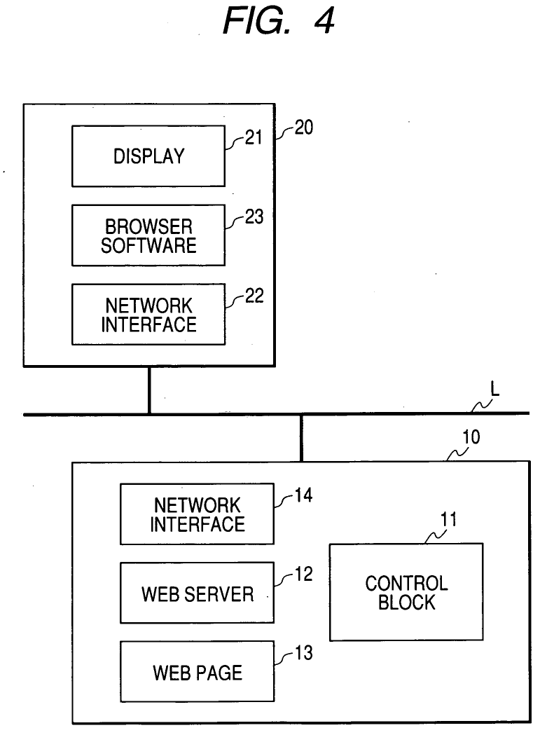

Upon receiving the instruction and the data, the computer 200 activates the browser software 23 (see FIG. 4) and initiates a display process in accordance with the display instruction. Then, the computer 200 presents, on the display device, data having a web page form related to either the electronic apparatus 100a or 100b.

As a result, the operator of the computer 200 can obtain desired data for the web page form.

Furthermore, since the data control apparatus 300 is arranged as is described above, the following operations are performed.

By accessing the data control apparatus 300, the computer 200 can obtain data stored in the electronic apparatuses 100a and 100b.

The data control apparatus 300 may combine data collected from a plurality of electronic apparatuses 100a and 100b, and may integrate these data to construct a web page.

At this time, the data integration method can be collectively managed by the data control apparatus 300, and can be changed merely by updating the data held by the data control apparatus 300. Therefore, the efficiency of the process is superior.

Conventionally, since a data management engine and a data conversion engine are mounted for the electronic apparatuses 100a and 100b, the efficiency and the performance are degraded. However, in the embodiment, the data obtained by the data control apparatus 300 is collectively managed, and an operation, such as a backup process, can be easily performed.

In this invention, since the data control apparatus 300 is located between the electronic apparatuses 100a and 100b and the computer 200, via the communication network L, the following function can be additionally provided.

(1) QoS (Quality of Service) Control for an Electronic Apparatus System

In accordance with a data request source and the request contents, the data control apparatus 300 controls the provision sequence for data and the band of the communication network L that is employed to provide the data. Through this control, a mechanism can be provided that identifies information having a high preference and preferentially transmits the information to the computer 200.

The system of the data control apparatus 300 may be designated, so as to provide a management service for the history of data requested by the computer 200. As a result, a request for data previously obtained by the computer 200 can be quickly responded to.

In addition, a plurality of data control apparatuses 300 may be positioned so as to interact via the communication network L. With this arrangement, the load imposed across the entire electronic apparatus system can be managed and controlled.

(2) Data Distribution Consonant with the Characteristic of an Access Source

The data control apparatus 300 may additionally include a function for distributing data having a form appropriate for the type of computer 200 accessing the network, or an attribute of the software or a person.

To display data on a computer 200, for example, this function of the data control apparatus 300 can identify an access source apparatus, and can distribute data while altering the contents of the display screen for a computer 200 or for a cellular phone.

(3) Acquisition of Security

Authentication information may be centrally located at the data control apparatus 300, so that security for an access made by a computer 200 can be maintained comparatively easily. Conventionally, authentication information for verifying users and computers is required to be provided for individual electronic apparatuses; it is not required, however, for this invention.

According to the invention, the security policy of an entire system can be updated merely by changing the data held by the data control apparatus 300. This is a convenient method.

When a technique such as VPN (Virtual Private Network) or SSL (Secure Sockets Layer) is employed to maintain secure communication, conventionally, a function for enabling the technique is required by each of the electronic apparatuses 100a and 100b, and an application compatible with the technique employed by the connected electronic apparatuses 100a and 100b is required by the computer 200.

On the other hand, according to the invention, a section wherein secure communication must be maintained is divided into two separate segments, one between the electronic apparatuses 100a and 100b and the data control apparatus 300 and one between the data control apparatus 300 and the computer 200, and as a result, and while taking existing circumstances into account, an appropriate technique can be employed for each segment.

(4) Integration of a Plurality of Devices

The data control apparatus 300 can shape, using a predesignated form, data provided in different forms by a plurality of electronic apparatuses 100a and 100b, and can transmit the shaped data to the computer 200.

That is, a function for transmitting setup information to the electronic apparatuses 100a and 100b is additionally provided for the data control apparatus 300, so that the setups of the electronic apparatuses 100a and 100b can be collectively managed.

The setup information may be transmitted by the computer 200, via the data control apparatus 300, to the electronic apparatuses 100a and 100b, or may be stored and managed by the data control apparatus 300.

Thus, when electronic apparatuses 100a and 100b of different types are connected to a network, architectural differences can be obtained by referring to setup information stored in the data control apparatus 300. Therefore, regardless of the types and the architectures of the electronic apparatuses 100a and 100b, the computer 200 can use a standard method to access them.

As is described above, according to the present invention, overall, a simple system can be constructed and cost increases can be avoided, and the number of operations required to respond to function updating requests and to performance improvement requests can be reduced.

1. An electronic apparatus system, comprising:
an electronic apparatus which transmits data through a communication network;
a data control apparatus which is connected to the electronic apparatus through the communication network and stores data transmitted from the electronic apparatus; and
a computer which enables to communicate with the data control apparatus,
wherein the data control apparatus transmits the stored data to the computer.

2. The electronic apparatus system according to claim 1,
wherein the data control apparatus structures the stored data into data having a form desired by the computer to transmit the data having the form to the computer.

3. The electronic apparatus system according to claim 2,
wherein the desired form is a web page form.

4. The electronic apparatus system according to claim 3,
wherein the data control apparatus comprises a storage section including a data storage section which stores the data transmitted from the electronic apparatus, and a web page setup section which sets up a web page.

5. The electronic apparatus system according to claim 4,
wherein the data control apparatus distributes a web page formed by combining data transmitted from a plurality of the electronic apparatuses.

6. The electronic apparatus system according to claim 1,
wherein the computer and the data control apparatus are integrally configured.

7. The electronic apparatus system according to claim 3,
wherein the data control apparatus controls a sequence of provision of the web page or a band of the communication network to be used for the provision of the web page, according to an access request source or access contents.

8. The electronic apparatus system according to claim 1,
wherein the data control apparatus manages a history of data requests made by the computer.

9. The electronic apparatus system according to claim 1,
wherein the data control apparatus changes a form of data to be provided, according to an attribute of an access source.

10. A data control apparatus which is connected to an electronic apparatus through a communication network and enables to communicate with a computer, comprising:
a data storing section which stores data transmitted from the electronic apparatus; and
a communication section which transmits data stored in the data storing section to the computer.
